(19) United States
(12) Patent Application Publication
(10) Pub. No.: US 2016/0243916 A1
(43) Pub. Date: Aug. 25, 2016

(54) DAMPER CONTROL DEVICE

(71) Applicant: KYB CORPORATION, Tokyo (JP)

(72) Inventors: Tomoo KUBOTA, Kanagawa (JP); Masatoshi OKUMURA, Gifu (JP)

(73) Assignee: KYB Corporation, Tokyo (JP)

(21) Appl. No.: 15/027,720

(22) PCT Filed: Nov. 21, 2014
(86) PCT No.: PCT/JP2014/080907

§ 371 Date: Apr. 7, 2016

(30) Foreign Application Priority Data
Dec. 24, 2013 (JP) 2013-265226

(51) Int. Cl. B60G 17/08; B60G 13/08; B60G 17/016; B60G 17/015

(52) U.S. Cl. CPC B60G 17/08; B60G 17/0152; B60G 13/08; B60G 17/016; B60G 2202/24; B60G 2400/91; B60G 2500/10

(57) ABSTRACT

A damper control device includes a vibration level detection unit configured to detect a vibration level of the unsprung member, and a control unit configured to control the damping force characteristics of the damper by obtaining a control instruction, the control instruction determining the damping force characteristics on the basis of the vibration level detected by the vibration level detection unit.

### TECHNICAL FIELD

The present invention relates to a damper control device.

### BACKGROUND ART

Damper control devices control a damping force of a damper interposed between a sprung member and an unsprung member of a vehicle. Some damper control devices, for example, adjust a damping force of a damper by adjusting the amount of electric current supplied to a solenoid valve provided within the damper.

Such damper control devices can adjust the damping force characteristics of the damper from soft damping force characteristics to hard damping force characteristics by supplying, to the solenoid, an electric current of an amount corresponding to the damping force characteristics of the damper.

For example, in order to set the damper to have soft damping force characteristics, an electric current of a constant amount corresponding to soft damping force characteristics is supplied to the solenoid. On the other hand, in order to set the damper to have hard damping force characteristics, an electric current of a constant amount corresponding to hard damping force characteristics is supplied to the solenoid (see, for example, JP11-287281A).

### SUMMARY OF INVENTION

Unless the sprung member of the vehicle vibrates to a great extent, the foregoing damper control devices can suppress vibrations of the sprung member and the unsprung member and realize favorable ride quality of the vehicle by causing the damper to exert predetermined damping force characteristics through supply of a constant electric current to the solenoid.

Incidentally, there is a method for obtaining a target electric current value for causing a damper to exert a target damping force from a map of a damping force, an electric current supplied to a solenoid valve, and a damper velocity. With this method, the map varies with each vehicle model because different vehicle models have different damping force characteristics. Furthermore, how a vehicle feels (the ride quality and the feeling of maneuverability) varies depending on how an electric current value is obtained in a case where a target damping force outside a map range is input. For this and other reasons, it takes time to perform an operation of adjusting how a vehicle feels for each vehicle model.

It is an object of the present invention to provide a damper control device that can reduce a time period required for an operation of adjusting how a vehicle feels.

According to one aspect of the present invention, a damper control device for controlling vibration of an unsprung member of a vehicle by controlling damping force characteristics of a damper relative to an extension/compression velocity of the damper, the damper being interposed between a sprung member and the unsprung member of the vehicle, the damper control device includes a vibration level detection unit configured to detect a vibration level of the unsprung member, and a control unit configured to control the damping force characteristics of the damper by obtaining a control instruction, the control instruction determining the damping force characteristics on the basis of the vibration level detected by the vibration level detection unit.

### BRIEF DESCRIPTION OF DRAWINGS

FIG. 1 shows a configuration of a damper control device according to an embodiment of the present invention.

FIG. 2 is a schematic vertical cross-sectional view of a damper.

FIG. 3 shows a variable range of damping force characteristics.

FIG. 4 shows a configuration of a vibration level detection unit.

FIG. 5 shows waveforms of level calculation signals.

FIG. 6 shows the frequency-phase characteristics of the level calculation signals.

FIG. 7 shows waveforms of absolute values of the level calculation signals.

FIG. 8 shows waveforms of absolute values of level calculation signals corresponding to an input original signal with a different frequency.

FIG. 9 shows waveforms of vibration levels.

FIG. 10 shows a relationship between a cutoff frequency of a ripple removal filter and a vibration level.

### DESCRIPTION OF EMBODIMENTS

An embodiment of the present invention will now be described with reference to the attached drawings.

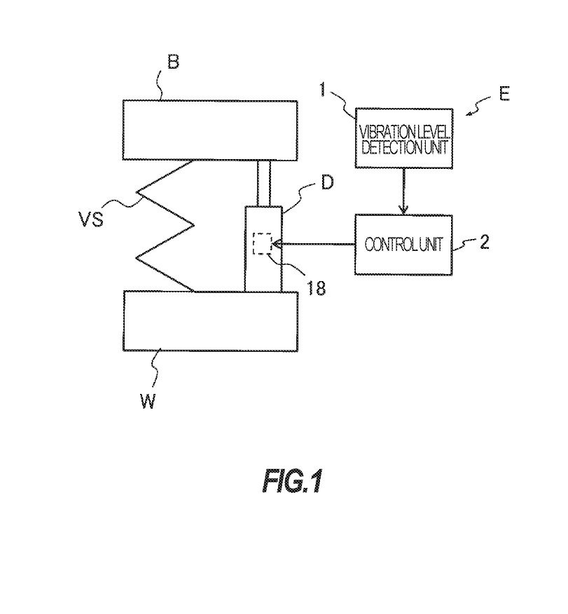

As shown in FIG. 1, in the present embodiment, a damper control device E controls a damping force of a damper D interposed between a sprung member B and an unsprung member W of a vehicle.

The damper control device E is provided with a vibration level detection unit 1 and a control unit 2. The vibration level detection unit 1 detects a vibration level r, which is a magnitude of the vibration of the unsprung member W. The control unit 2 controls the damping force characteristics, which are the characteristics of a damping force of the damper D relative to the extension/compression velocity of the damper D, on the basis of the vibration level r detected by the vibration level detection unit 1.

In the present embodiment, the damper D is interposed between the sprung member B and the unsprung member W of the vehicle in parallel with a suspension spring VS. The sprung member B is elastically supported by the suspension spring VS. The unsprung member W includes a wheel and a link that are swingably attached to the sprung member B, which is a vehicle body.

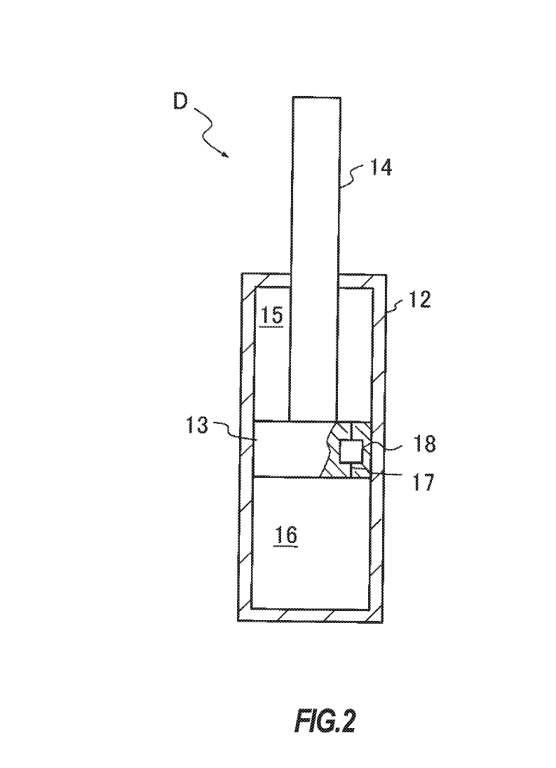

For example, as shown in FIG. 2, the damper D is a fluid pressure damper provided with a cylinder 12, a piston 13, a piston rod 14, pressure chambers 15, 16, a damping force adjustment passage 17, and a proportional solenoid valve 18. The piston 13 is slidably inserted into the cylinder 12. The piston rod 14 is movably inserted into the cylinder 12, and is joined to the piston 13. The pressure chambers 15, 16 are partitioned by the piston 13 in the cylinder 12, and communicate with each other via the damping force adjustment passage 17. The proportional solenoid valve 18 serves as a damping force adjustment unit that applies resistance to the flow of a working fluid passing through the damping force adjustment passage 17.

When a working fluid that fills the pressure chambers 15, 16 passes through the damping force adjustment passage 17 in accordance with an extension/compression operation, the proportional solenoid valve 18 applies resistance to the flow of the working fluid, and the damper D accordingly exerts a damping force for suppressing the extension/compression operation. In this way, the damper D suppresses relative movements of the sprung member B and the unsprung member W.

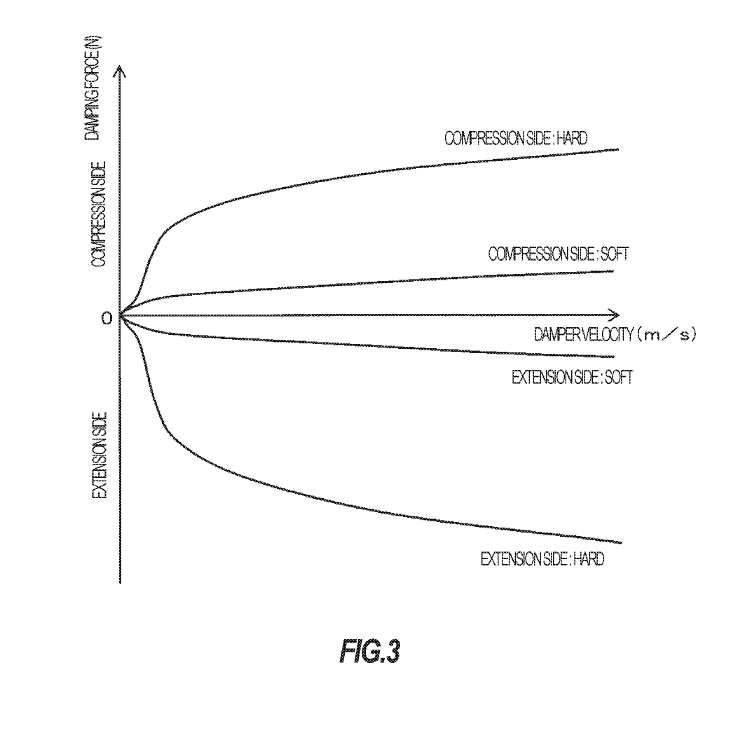

The cylinder 12 is filled with a liquid serving as a working fluid, such as working oil, water, and water solution. The proportional solenoid valve 18, for example, can adjust the damping force characteristics of the damper D in a range from soft damping force characteristics to hard damping force characteristics as shown in FIG. 3, by changing the damping force characteristics of the damper D in accordance with a magnitude of an electric current that is supplied on the basis of a control instruction issued by the control unit 2.

With the damper D, an actual vehicle evaluation is made for each amount of electric current supplied to the proportional solenoid valve 18. The damper D accordingly has appropriate damping force characteristics (characteristics defined by an orifice, an extension-to-compression ratio representing a ratio between an extension-side damping force and a compression-side damping force, and the like).

Therefore, application of a constant electric current to a solenoid of the proportional solenoid valve 18 enables the input vibration to recede, although a time period required until the recession of the vibration varies. As a result, the ride quality of the vehicle is not impaired.

It is sufficient for the proportional solenoid valve 18 to be composed of, for example, a valve body (not shown) that makes the flow passage area of the damping force adjustment passage 17 variable, and a solenoid capable of adjusting the flow passage area of the damping force adjustment passage 17 by driving the valve body. It should be noted that the valve body may be driven by an actuator other than the solenoid. In this case, the flow passage area of the damping force adjustment passage 17 is adjusted by increasing or decreasing the amount of electric current supplied to the actuator. In this way, the damping force exerted by the damper D can be adjusted by changing the resistance applied to the working fluid flowing through the damping force adjustment passage 17.

The damping force adjustment unit may be an element other than the proportional solenoid valve 18. For example, in a case where the working fluid is a viscous magnetofluid, the damping force adjustment unit is a device that causes a magnetic field to act on the damping force adjustment passage 17. In this case, a magnitude of the magnetic field is adjusted by the amount of electric current supplied from the damper control device E. In this way, the damping force of the damper D is made variable by changing the resistance applied to the flow of the viscous magnetofluid passing through the damping force adjustment passage 17.

Furthermore, for example, in a case where the working fluid is a viscous electrofluid, the damping force adjustment unit is a device capable of causing an electric field to act on the damping force adjustment passage 17. In this case, a magnitude of the electric field is adjusted by a voltage supplied from the damper control device E. In this way, the damping force of the damper D is made variable by changing the resistance applied to the viscous electrofluid passing through the damping force adjustment passage 17.

Furthermore, in a case where the working fluid is a liquid and the damper D is of a single-rod type, the damper D is provided with a gas chamber and a reservoir to compensate for the volume by which the piston rod 14 enters and exits the cylinder 12. In contrast, in a case where the working fluid is gas, the gas chamber and the reservoir need not be provided.

Furthermore, in a case where the damper D is of a uniflow type whereby a reservoir is provided therein and the working fluid is discharged through a passage from the inside of the cylinder 12 to the reservoir at the time of either extension or compression, a damping force adjustment unit that applies resistance to the flow of the working fluid may be provided in the course of the passage from the cylinder 12 to the reservoir.

The damper D may be an electromagnetic damper that exerts a damping force due to an electromagnetic force. The electromagnetic damper is, for example, provided with a motor and a motion conversion mechanism that converts a rotary motion of the motor into a linear motion. Alternatively, the electromagnetic damper is a linear motor. In a case where the damper D is the electromagnetic damper, it is sufficient for the damping force adjustment unit to be a motor driving device that adjusts an electric current flowing through the motor or the linear motor.

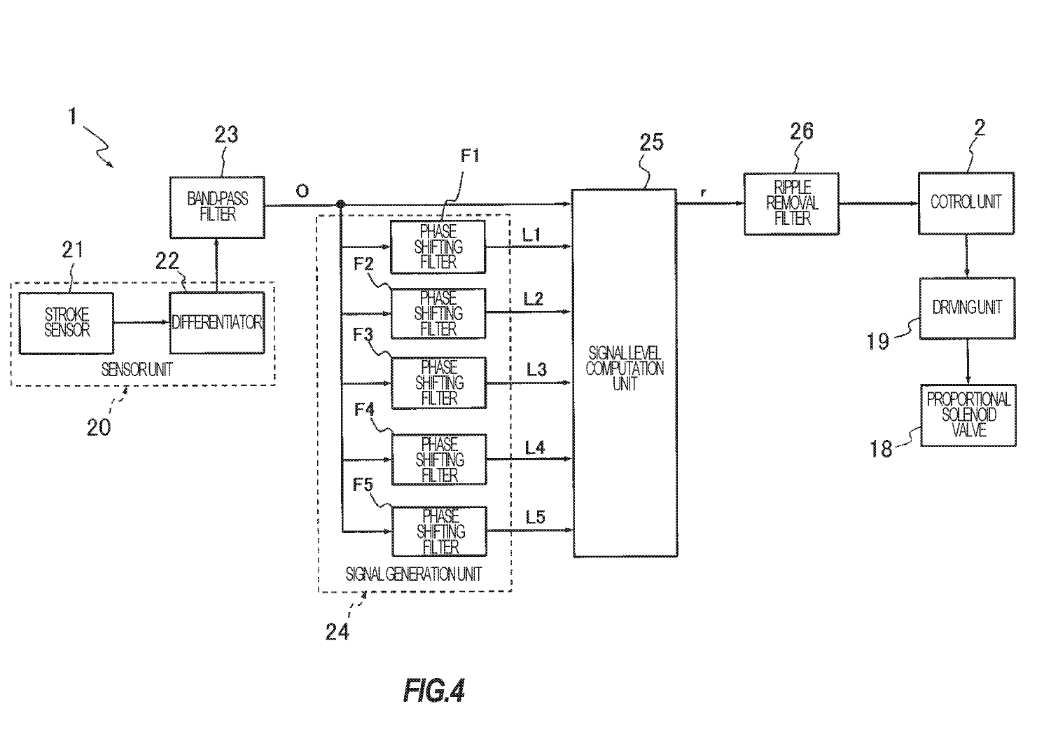

As shown in FIGS. 1 and 4, the vibration level detection unit 1 is provided with a sensor unit 20, a band-pass filter 23, a signal generation unit 24, a vibration level computation unit 25, and a ripple removal filter 26. The sensor unit 20 is provided with a stroke sensor 21 that detects a stroke displacement of the damper D, and a differentiator 22 that obtains a damper velocity from the damper displacement detected by the stroke sensor 21. The band-pass filter 23 extracts a resonant frequency component of the unsprung member W from the damper velocity output from the sensor unit 20, and outputs the extracted resonant frequency component as an original signal O. With the use of the original signal O, the signal generation unit 24 generates two or more level calculation signals that have the same amplitude as the original signal O and are out of phase with one another. The vibration level computation unit 25 obtains the maximum value among the absolute values of the original signal O and the level calculation signals, and uses the obtained maximum value as a vibration level r. The ripple removal filter 26 removes a high-frequency component from the vibration level r obtained by the vibration level computation unit 25. In the present embodiment, the signal generation unit 24 generates five level calculation signals L1 to L5.

The stroke sensor 21 is interposed between the sprung member B and the unsprung member W, and detects a stroke displacement of the damper D. The stroke sensor 21 may be provided integrally with the damper D.

The differentiator 22 obtains a damper velocity by differentiating the stroke displacement, and outputs the obtained damper velocity. It goes without saying that the damper velocity can be obtained using a sensor that obtains vibration information, such as the acceleration, velocity, and displacement of the unsprung member W in the up-down direction, in place of the stroke sensor 21.

The band-pass filter 23 extracts a vibration component in a unsprung resonant frequency band from the damper velocity, and outputs the extracted vibration component as the original signal O. Once the damper velocity has been processed by the band-pass filter 23, that is to say, once the damper velocity has been filtered using the band-pass filter 23, the resultant damper velocity is delayed in phase at the initial rise relative to the damper velocity output from the differentiator 22.

The signal generation unit 24 then obtains five level calculation signals L1 to L5 that have the same amplitude as the original signal O and are out of phase with one another. Specifically, in order to obtain level calculation signals Ln (n=1, 2, 3, 4, 5) from the original signal O, the signal generation unit 24 is provided with phase shifting filters F1 to F5 that shift only the phase of the original signal O while leaving the amplitude of the original signal O unchanged.

In the signal generation unit 24, the phase shifting filters F1 to F5 are arranged in parallel, and filter processing is applied to the original signal O using the phase shifting filters F1 to F5. It is sufficient that the phase shifting filters be provided in one-to-one correspondence with the level calculation signals. In the present case, it is sufficient to provide five phase shifting filters in correspondence with the level calculation signals L1 to L5.

A transfer function G(s) of the phase shifting filters F1 to F5 is set by the following expression (1). In expression (1), O(s) denotes the amount of Laplace transform of the original signal O, Ln(s) (n=1, 2, 3, 4, 5) denotes the amount of Laplace transform of the level calculation signals Ln (n=1, 2, 3, 4, 5), s denotes a Laplace operator, and ωn (n=1, 2, 3, 4, 5) denotes frequency. It should be noted that different frequencies are set to ω1 to ω5.

$$\begin{matrix}[ Math . 1 ] & \\ G ( s ) = \frac{L n ( s )}{O ( s )} = \frac{- s + {ω}_{n}}{s + {ω}_{n}} & ( 1 )\end{matrix}$$

The signal generation unit 24 accordingly obtains the level calculation signals Ln (n=1, 2, 3, 4, 5) from the original signal O using the phase shifting filters Fn (n=1, 2, 3, 4, 5) for which a transfer function G(s) with a frequency of ωm (n=1, 2, 3, 4, 5) is set.

For example, in order to obtain the level calculation signal L4 from the original signal O, the signal generation unit 24 applies filter processing to the original signal O using the phase shifting filter F4 for which a transfer function G(s) is set by inputting a frequency of ω4.

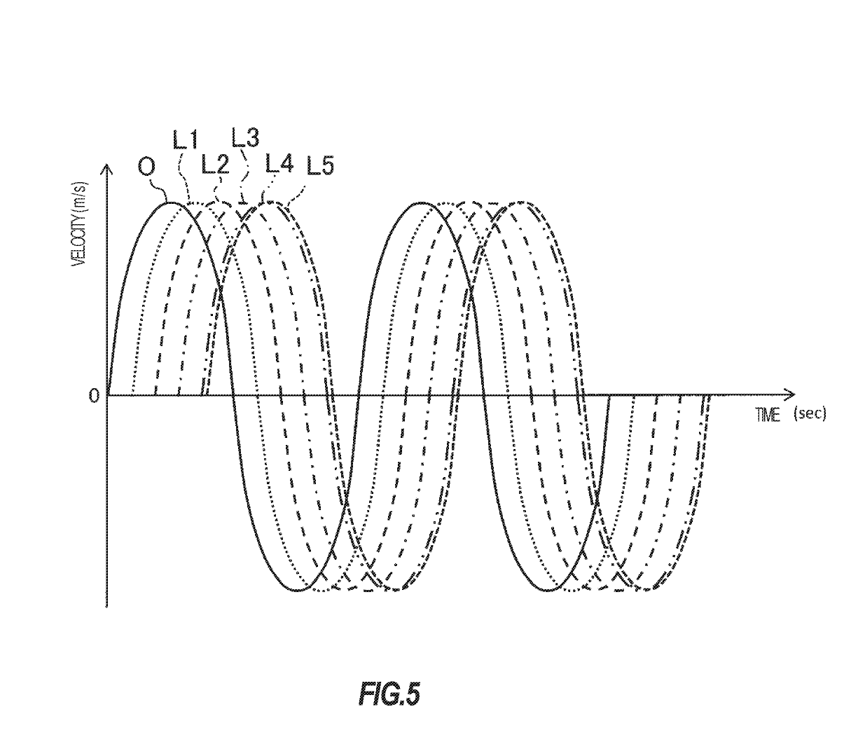

As such, the signal generation unit 24 obtains the level calculation signals L1 to L5 using the phase shifting filters F1 to F5. In this way, as shown in FIG. 5, the five level calculation signals L1 to L5 that have the same amplitude as the original signal O with a certain frequency x and are only out of phase with one another can easily be obtained.

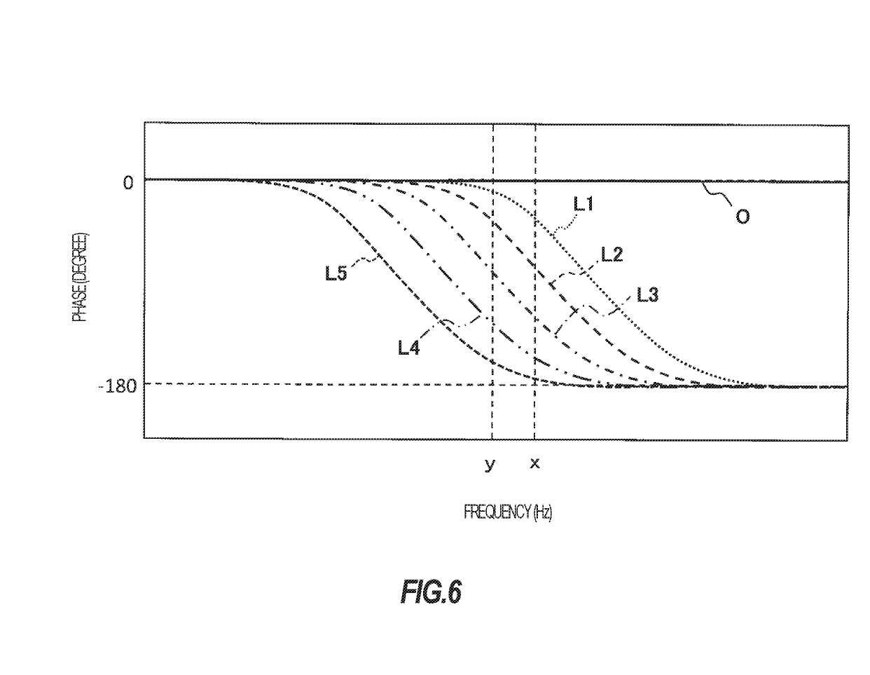

Although the phase difference between the original signal O and the level calculation signal L1 and the phase differences between the level calculation signals L1 to L4 are represented by an equal interval, the phase difference between the level calculation signal L4 and the level calculation signal L5 is different from the phase difference between the original signal O and the level calculation signal L1 and from the phase differences between the level calculation signals L1 to L4. This is because, as shown in FIG. 6, the frequency-phase characteristics of the level calculation signals L1 to L4 exhibit changes in a range from an upper limit of 0 degrees to a lower limit of −180 degrees, that is to say, a restriction defined between 0 degrees and −180 degrees.

In a case where the original signal O has an extremely low frequency, the phases of the level calculation signals L1 to L5 are 0 degrees or in the vicinity of 0 degrees. In a case where the original signal O has an extremely high frequency, the phases of the level calculation signals L1 to L5 are −180 degrees or in the vicinity of −180 degrees. For this reason, as shown in FIG. 5, the phase differences between the level calculation signals L1 to L4 are represented by an equal interval, whereas the phase difference between the level calculation signal L5 and the adjacent level calculation signal L4 decreases towards a phase of −180 degrees.

A transfer function G(s) of the phase shifting filters F1 to F5 may also be set by the following expression (2). In expression (2), O(s) denotes the amount of Laplace transform of the original signal O, Ln(s) (n=1, 2, 3, 4, 5) denotes the amount of Laplace transform of the level calculation signals Ln (n=1, 2, 3, 4, 5), s denotes a Laplace operator, and ωm (n=1, 2, 3, 4, 5) denotes frequency. It should be noted that different frequencies are set to ω1 to ω5.

$$\begin{matrix}[ Math . 2 ] & \\ G ( s ) = \frac{L n ( s )}{O ( s )} = \frac{s - {ω}_{n}}{s + {ω}_{n}} & ( 2 )\end{matrix}$$

The phase shifting filters F1 to F5 may also be second-order low-pass filters. Specifically, a transfer function G(s) of the phase shifting filters F1 to F5 may also be set by the following expression (3). In expression (3), O(s) denotes the amount of Laplace transform of the original signal O, Ln(s) (n=1, 2, 3, 4, 5) denotes the amount of Laplace transform of the level calculation signals Ln (n=1, 2, 3, 4, 5), s denotes a Laplace operator, ζ denotes a damping ratio, and ωm (n=1, 2, 3, 4, 5) denotes a cutoff frequency. It should be noted that different cutoff frequencies are set to ω1 to ω5.

$$\begin{matrix}[ Math . 3 ] & \\ G ( s ) = \frac{L n ( s )}{O ( s )} = \frac{{ω}_{n}^{2}}{{s}^{2} + 2 ζ {ω}_{n} s + {ω}_{n}^{2}} & ( 3 )\end{matrix}$$

By using low-pass filters as the phase shifting filters F1 to F5, the level calculation signals L1 to L5 can be delayed in phase relative to the original signal O. On the other hand, by using high-pass filters as the phase shifting filters F1 to F5, the level calculation signals L1 to L5 can be advanced in phase relative to the original signal O. Thus, it is possible to use a high-pass filter as a part of the phase shifting filters F1 to F5, and to use a low-pass filter as the rest of the phase shifting filters F1 to F5.

The signal generation unit 24 obtains, from the original signal O, the level calculation signals L1 to L5 that are out of phase with one another. In view of this, signals that are sequentially delayed by a prescribed time period relative to the original signal O may be generated as the level calculation signals L1 to L5 without using the above-described filter processing.

The vibration level computation unit 25 obtains the maximum value among signals that have been obtained by applying absolute value processing to the original signal O and the level calculation signals L1 to L5.

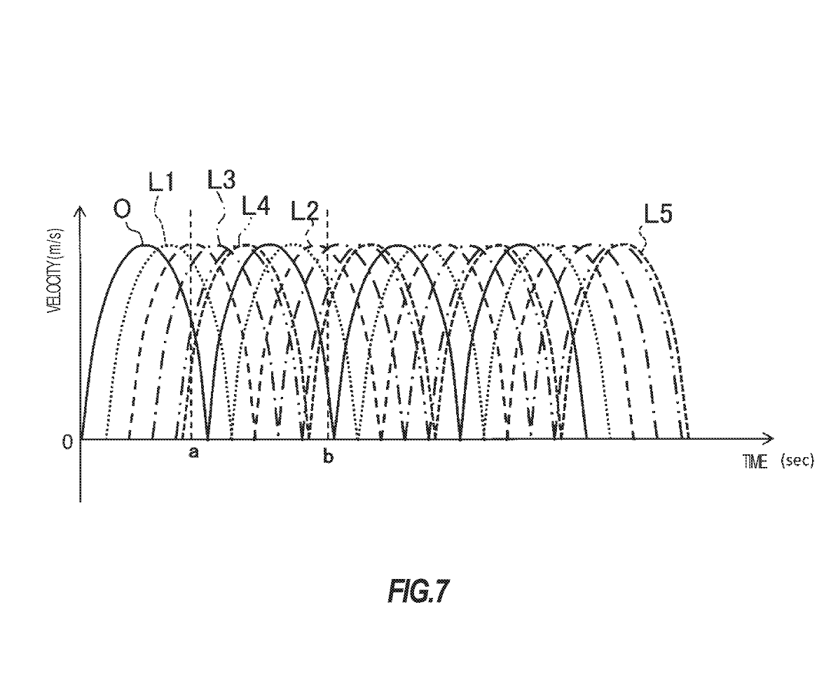

Once the absolute value processing has been applied to the original signal O and the level calculation signals L1 to L5, the waveforms of the resultant original signal O and the resultant level calculation signals L1 to L5 have the shapes shown in FIG. 7. That is to say, out of the waveforms of the original signal O and the level calculation signals L1 to L5, parts that have negative values are flipped toward the positive side with respect to the time axis.

The absolute values of the original signal O and the level calculation signals L1 to L5 are out of phase with one another. Therefore, even if the absolute value processing has been applied to the original signal O and the level calculation signals L1 to L5, the waveforms of the resultant original signal O and the resultant level calculation signals L1 to L5 temporally differ from one another.

As a result of such absolute value processing, as shown in FIG. 7, at any point in time, the maximum value among the resultant original signal O and the resultant level calculation signals L1 to L5 is equal to or approximates the maximum amplitude of the original signal O.

For example, at time a, the maximum value among the resultant original signal O and the resultant level calculation signals L1 to L5 is the maximum value of the level calculation signal L2. On the other hand, at time b, the maximum value among the resultant original signal O and the resultant level calculation signals L1 to L5 approximates the value of the maximum amplitude of the original signal O.

The maximum amplitudes of the level calculation signals L1 to L5 are equal to the maximum amplitude of the original signal O in terms of velocity. As the original signal O is a component of the extension/compression velocity of the damper D in the unsprung resonant frequency band and is substantially equal to the velocity of the unsprung member W, the maximum amplitude of the original signal O is equal to a vibration level r of the unsprung member W measured on the basis of velocity. That is to say, the maximum value within one cycle of the original signal O serves as the vibration level r of the unsprung member W. However, the vibration level of the unsprung member W cannot be obtained in a timely fashion by way of sampling within one cycle of the original signal O. In addition, if the frequency of the vibration of the unsprung member W changes, a time period required for one cycle of the original signal O changes, and thus the maximum amplitude cannot be obtained.

In contrast, by generating the level calculation signals L1 to L5 that have the same amplitude as the original signal O and are only out of phase with one another in the above-described manner, one of the original signal O and the level calculation signals L1 to L5 that have been subjected to the absolute value processing is expected to have the maximum value or a value close to the maximum value at the time of computing the vibration level r. Therefore, by obtaining the maximum value among the original signal O and the level calculation signals L1 to L5 that have been subjected to the absolute value processing as the vibration level r, the value of the obtained vibration level r is exactly equal to or approximates the value of the maximum amplitude of the original signal O.

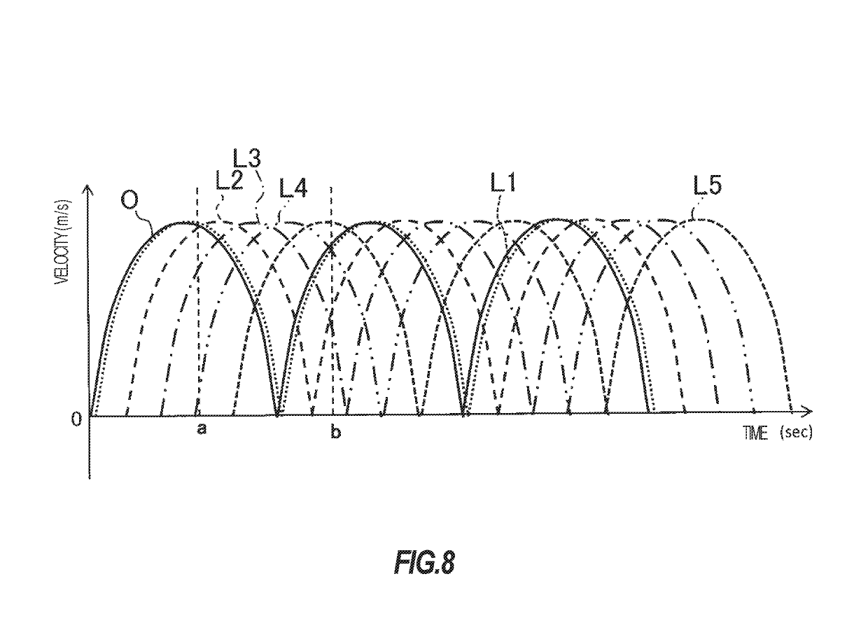

In this way, for example, even in a case where an original signal O with a frequency y, which is lower than the frequency x, has been input as shown in FIG. 8, the maximum value among the original signal O and the level calculation signals L1 to L5, which are out of phase with the original signal O, at the time of computation is obtained as the vibration level r. Therefore, the value of the vibration level r is equal to or approximates the value of the maximum amplitude of the original signal O. That is to say, even if the frequency of the original signal O changes, a value that approximates the value of the maximum amplitude of the original signal O can be obtained as the vibration level r.

It should be noted that, in FIG. 8, the phase differences between the level calculation signals L1 to L5 are represented by an equal interval, whereas the phase difference between the original signal O and the level calculation signal L1 is different from the phase differences between the level calculation signals L1 to L5. This is because, as opposed to the fixed, 0-degree phase of the original signal O, the phase of the level calculation signal L1 is restricted by the upper limit of 0 degrees as the frequency lowers, as shown in FIG. 6. As a result, the phase of the level calculation signal L1 is close to 0 degrees, thereby reducing the phase difference between the level calculation signal L1 and the original signal O.

In a range with a frequency lower than the frequency y, the phase difference between the level calculation signal L1 and the adjacent level calculation signal L2 is also small. However, even in the case of a low frequency, a value that approximates the value of the maximum amplitude of the original signal O can be obtained as the vibration level r using the level calculation signals L2 to L5 whose phase differences are represented by an equal interval. In this way, even if the frequency of the original signal O changes, the vibration level detection unit 1 can obtain a value that is equal to or approximates the value of the maximum amplitude of the original signal O as the vibration level r in real time and in a timely fashion. Hence, the vibration level r can be obtained accurately with respect to a signal in wide frequency bands.

Furthermore, in the present embodiment, the original signal O is a velocity representing vibration information of the unsprung member W. Therefore, by detecting the vibration level r in the above-described manner, the magnitude of vibration (vibration level) of the unsprung member W can be detected in real time and in a timely fashion. The vibration level r thus obtained has a small temporal delay relative to the vibration of the unsprung member W, and is hence sufficiently sustainable when used in, for example, control for suppressing the vibration of a vehicle.

Although the vibration level r of the unsprung member W is obtained using the original signal O and the level calculation signals L1 to L5 in the present embodiment, the vibration level r can be obtained accurately by generating, from the original signal O, three or more level calculation signals that are out of phase with one another in a frequency bandwidth in which the vibration level r of the unsprung member W is desired to be obtained from the original signal O. Therefore, the vibration level computation unit 25 may obtain the vibration level r by carrying out the above-described procedure using only the level calculation signals without using the original signal O.

Furthermore, in the present embodiment, a damper velocity is obtained from a stroke displacement of the damper D detected by the stroke sensor 21, and then the vibration level r of the unsprung member W is detected by extracting a frequency component of the damper velocity in the unsprung resonant frequency band. Here, as the unsprung member W and the sprung member B are connected via the damper D and the suspension spring VS, vibration information of the sprung member B is always influenced by the vibration of the unsprung member W. In addition, the waveform of the vibration level of the sprung member B approximates the waveform of the vibration level r of the unsprung member W. Therefore, the vibration level r of the unsprung member W can be substituted with a vibration level obtained using detected vibration information of the sprung member B, that is to say, the acceleration, velocity, or displacement of the sprung member B in the up-down direction.

In this way, the vibration level r of the unsprung member W can be obtained without directly obtaining vibration information of the unsprung member W, such as the acceleration, velocity, or displacement of the unsprung member W in the up-down direction. That is to say, detection of the vibration level r of the unsprung member W encompasses substitution of the vibration level r of the unsprung member W with the vibration level obtained from the vibration information of the sprung member B.

Therefore, in a case where control according to the present embodiment is performed together with another control for obtaining the vibration information of the sprung member B, a sensor for obtaining the vibration information of the sprung member B is used, which renders a sensor for obtaining the vibration information of the unsprung member W unnecessary. Accordingly, the number of sensors can be reduced.

Furthermore, although the phase shifting filters F1 and F5 obtain the level calculation signals L1 to L5 by processing the original signal O in parallel, the phase shifting filters F1 to F5 may be arranged in series.

In this case, the level calculation signal L1 is obtained first by processing the original signal O using the phase shifting filter F1, the level calculation signal L2 is obtained next by processing the level calculation signal L1 using the phase shifting filter F2, and so on. In this way, a level calculation signal that has been processed using an immediately preceding phase shifting filter is processed using an immediately succeeding phase shifting filter to obtain a resultant level calculation signal.

As shown in FIG. 6, the frequency-phase characteristics of the level calculation signals exhibit changes in a range from the upper limit of 0 degrees to the lower limit of −180 degrees. The level calculation signals approach 0 degrees in phase with a decrease in frequency. On the other hand, the level calculation signals approach −180 degrees in phase with an increase in frequency. For this reason, at the high frequency x, the phase differences between the original signal O and the level calculation signals L1 to L4 that have been processed using the phase shifting filters F1 to F5 are represented by an equal interval, and the value of the obtained vibration level r is equal to or approximates the maximum amplitude of the original signal O. On the other hand, at the low frequency y, the phase differences between the level calculation signals L1 to L5 are represented by an equal interval, and the value of the obtained vibration level r is equal to or approximates the maximum amplitude of the original signal O.

That is to say, the vibration level r can be detected accurately with respect to the original signal O in a range from the high frequency x to the low frequency y.

As described above, the original signal O and the level calculation signals L1 to L4 generated using the phase shifting filters F1 to F4 contribute to detection of the vibration level r with respect to the original signal O with the frequency x. On the other hand, the phase shifting filters F1 to F5 contribute to detection of the vibration level r with respect to the original signal O with the frequency y. It is apparent from the foregoing that the phase shifting filters contributing to detection of the vibration level r vary depending on the frequency of the original signal O.

In view of this, the frequency bandwidth in which the vibration level r of the unsprung member W can be detected accurately can be widened in the following manner. In a case where the original signal O is used together with the level calculation signals, it is sufficient to disperse the original signal O and at least two level calculation signals such that their phase differences are represented by an equal interval within a 180-degree phase range between a lower limit and an upper limit of a frequency bandwidth. On the other hand, in a case where the vibration level r is obtained using only the level calculation signals, it is sufficient to disperse at least three level calculation signals such that their phase differences are represented by an equal interval within a 180-degree phase range. It is thus sufficient to determine the number of filters provided to generate the level calculation signals in accordance with the number of the level calculation signals to be generated.

Therefore, the vibration level r can be detected with respect to a signal in wide frequency bands, and the accuracy is improved as well, by configuring the signal generation unit 24 to generate the level calculation signals L1 to L5 with respect to the input original signal O such that the original signal O and the level calculation signals L1 to L5, which contribute to detection of the vibration level r, are dispersed with phase differences represented by an equal interval of 60 degrees or smaller within a 180-degree phase range.

This is because, provided that signals are represented by sine waves, if the vibration level r is obtained by generating three level calculation signals that are out of phase with one another by 60 degrees, the vibration level r does not fall below at least 0.85 times the wave height of the original signal O of a mass. In this way, a favorable vibration level r can be obtained.

It should be noted that, in a case where the original signal O is used only in generation of level calculation signals, the vibration level r can be detected with respect to a signal in wide frequency bands, and the accuracy is improved as well, by configuring the signal generation unit 24 to generate the level calculation signals L1 to L5, which contribute to detection of the vibration level r, such that the level calculation signals L1 to L5 are dispersed with phase differences represented by an equal interval of 60 degrees or smaller within a 180-degree phase range.

Furthermore, in a case where a large number of level calculation signals are generated with respect to an input original signal O with a certain frequency such that the phase differences between the level calculation signals are represented by an equal interval within a 180-degree phase range and these phase differences between the level calculation signals are small, there is no practical problem in using the maximum value among the absolute values of the level calculation signals as the vibration level r, using the second or third largest value thereamong as the vibration level r, or using an average value of the maximum value and the second largest value thereamong as the vibration level r.

For example, provided that signals are represented by sine waves, if 12 level calculation signals are generated such that they are out of phase with one another by 15 degrees, even when the third largest value among the absolute values of the level calculation signals is used as the vibration level r, the vibration level r does not fall below at least 0.9 times the wave height of the original signal O of the mass. Therefore, a favorable vibration level r can be obtained. It should be noted that, in this case also, the maximum value among the absolute values of the level calculation signals is closest to the actual vibration level r. It is thus preferable to obtain the maximum value as the vibration level r.

In the present embodiment, the vibration level r of the unsprung member W obtained in the above-described manner is processed by the ripple removal filter 26. The ripple removal filter 26 is a low-pass filter that is provided for the purpose of removing a high-frequency component included in the vibration level r. By filtering the vibration level r using the ripple removal filter 26, the resultant vibration level r is delayed in phase relative to the actual vibration level of the unsprung member W.

As set forth above, the damper velocity is delayed in phase at the initial rise by filtering the damper velocity using the band-pass filter 23, the vibration level r is obtained from the damper velocity whose initial phase has been delayed, and the vibration level r is filtered using the ripple removal filter 26. The resultant vibration level r, as a whole, is delayed in phase relative to the actual vibration level of the unsprung member W.

The control unit 2 obtains, from the vibration level r obtained in the above-described manner, a control instruction to be issued to a driving unit 19. The control unit 2 then outputs the control instruction to the driving unit 19 that drives the proportional solenoid valve 18. The driving unit 19 is provided with, for example, a PWM circuit and the like, and supplies an electric current I to the proportional solenoid valve 18 in accordance with the control instruction obtained by the control unit 2.

Specifically, the control unit 2 obtains the control instruction by multiplying the vibration level r by a proportional gain, and inputs the obtained control instruction to the driving unit 19 as shown in FIG. 4 so as to cause the driving unit 19 to output an electric current according to the control instruction to the proportional solenoid valve 18. In the present case, as the damping force adjustment unit is the proportional solenoid valve 18, the control instruction output to the driving unit 19 is an electric current instruction.

Upon receiving the electric current supplied from the driving unit 19, the proportional solenoid valve 18 adjusts the damping force characteristics of the damper D. The damper D accordingly exerts a damping force corresponding to a damper velocity at that time. As such, a damping force of the damper D is controlled by the damper control device E.

As described above, the damper control device E controls a damping force of the damper D by obtaining the vibration level r of the unsprung member W, generating the control instruction from the vibration level r, and supplying an electric current to the proportional solenoid valve 18 in accordance with the control instruction.

The vibration level r detected by the vibration level detection unit 1 is delayed in phase relative to the actual vibration level of the unsprung member W. Accordingly, the control instruction is also temporally delayed relative to the actual vibration level of the unsprung member W.

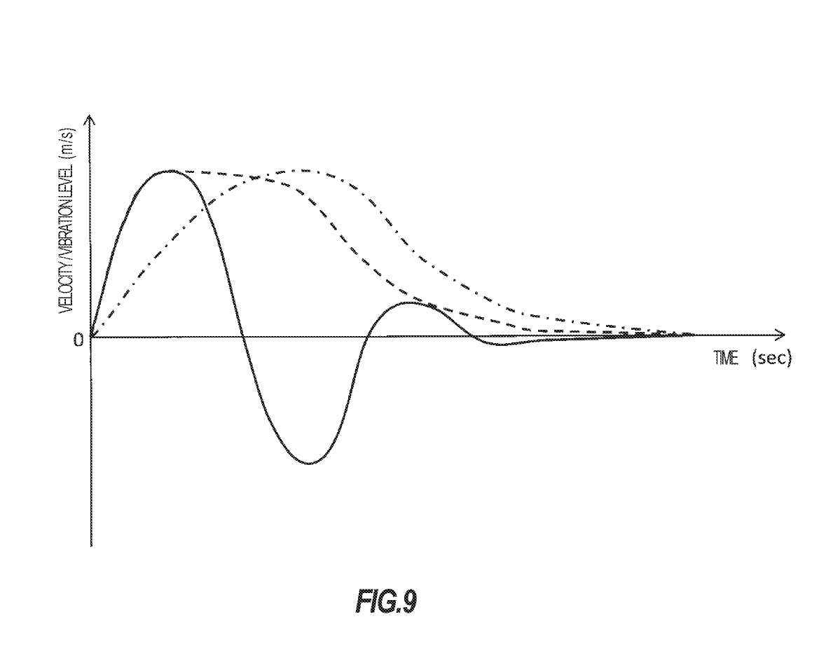

More specifically, for example, in a case where a vehicle passes over a protrusion on a road surface, the velocity of the unsprung member W in the up-down direction takes the form of a solid line shown in FIG. 9. In FIG. 9, the horizontal axis represents time after a wheel comes into contact with the protrusion. On the other hand, the vertical axis represents the velocity, or the magnitude of the vibration level, of the unsprung member W.

As indicated by the solid line in FIG. 9, in a case where a vehicle passes over a protrusion on a road surface, the velocity of the unsprung member W in the up-down direction increases after a wheel comes into contact with the protrusion. As indicated by a dash line in FIG. 9, the value of the actual vibration level of the unsprung member W also increases immediately after the unsprung member W is thrusted upward by the protrusion.

In contrast, the vibration level r detected by the vibration level detection unit 1, as a whole, is delayed in phase relative to the actual vibration level of the unsprung member W, because the damper velocity used in obtaining the vibration level r is filtered using the band-pass filter 23, and because the vibration level is filtered using the ripple removal filter 26. For this reason, as indicated by a dash-and-dot line in FIG. 9, the rise of the vibration level r is delayed.

In this way, in a case where a vehicle passes over a protrusion on a road surface, as the sprung member is intended to proceed straight despite the contact between a wheel and the protrusion, the unsprung member W is abruptly thrusted upward with the compression of the damper D, and the actual vibration level of the unsprung member W increases. Furthermore, a damping force exerted by the damper D is kept small due to the vibration level r that is delayed relative to the actual vibration level.

Accordingly, the velocity of the unsprung member W in the up-down direction increases abruptly. Thereafter, as the vibration level r detected by the vibration level detection unit 1 increases, the extension of the damper D is suppressed by a large damping force, and the vibration of the unsprung member W is headed toward recession.

As set forth above, in the case of the damper D controlled by the damper control device E, immediately after a wheel comes into contact with a protrusion on a road surface as a vehicle passes over the protrusion, the vibration level r is low, and a damping force for suppressing the abrupt compression of the damper D is small. Thereafter, once the damper D has made a transition from the compression operation to the extension operation, the value of the vibration level r increases. This makes the damper D exert a large damping force so as to prevent the extension, thereby suppressing the vibration of the unsprung member W.

On the other hand, immediately after a wheel enters a recessed section of a road surface as a vehicle passes over the recessed section, the vibration level r is low, and a damping force for suppressing the abrupt extension of the damper D is small. Thereafter, once the damper D has made a transition from the extension operation to the compression operation, the value of the vibration level r increases. This makes the damper D exert a large damping force so as to prevent the compression, thereby suppressing the vibration of the unsprung member W.

As such, the damper control device E can prevent an increase in the acceleration peak value of the sprung member B by maintaining a small damping force with respect to the compression of the damper D when running over a protrusion on a road surface, or the extension of the damper D when entering a recessed section. The damper control device E can also suppress the wheel tramp of the unsprung member W by exerting a large damping force with respect to the extension or compression after the extension/compression direction of the damper D is reversed.

Therefore, in a case where a vehicle drives over a protrusion or a recessed section of a road surface, the damper control device E can not only enhance the insulation against transmission of vibration from the unsprung member W to the sprung member B, but also promptly control the vibration of the unsprung member W by suppressing the wheel tramp of the unsprung member W. This can improve the ride quality of the vehicle when driving over a protrusion or a recessed section of a road surface.

Furthermore, the damper control device E can control a damping force of the damper D simply by multiplying the vibration level r by a proportional gain so as to directly generate a control instruction equivalent to an electric current instruction, instead of using a damping force instruction. That is to say, a control instruction can easily be obtained from the vibration level r because the obtainment of the control instruction involves neither map computation that uses an electric current instruction computation map showing a relationship among a damping force, an electric current supplied to the proportional solenoid valve 18, and a damper velocity, nor other complex computations.

It is necessary to prepare the electric current instruction computation map for each vehicle model because the damping force characteristics of the damper D vary with each vehicle. This makes it necessary to research a relationship among a damping force, an electric current supplied to a valve for adjusting the damping force characteristics, and a damper velocity, and also to incorporate the result of the research into a map, for each vehicle model.

In contrast, the present embodiment determines a control instruction for adjusting the damping force characteristics without obtaining an electric current instruction computation map, and thus can reduce the foregoing mapping process. Therefore, the present embodiment does not need to use an electric current instruction computation map, which varies with each vehicle model, and does not require an investment of time for an operation of adjusting how a vehicle feels. This can reduce time required for an operation of adjusting how a vehicle feels.

Incidentally, antivibration rubber called a mount is typically interposed between the damper D and the sprung member B. A relative displacement of the sprung member B and the unsprung member W is equal to a sum of a stroke of the damper D and a displacement of the mount.

The unsprung member W resonates with a high-frequency band. Therefore, the amount of a stroke of the damper D caused by resonance of the unsprung member W is extremely small. This makes a displacement of the mount relatively large. A method for detecting a damper velocity typically uses a stroke sensor that detects a relative displacement of the sprung member B and the unsprung member W, and acceleration sensors mounted on the sprung member B and the unsprung member W.

A damping force of the damper D can be controlled by obtaining a target damping force to be exerted by the damper D, and by obtaining the amount of electric current supplied to, for example, a valve that adjusts a damping force of the damper D from the target damping force and a damper velocity. However, in this case, there is a large difference between the actual damper velocity of the damper D and the damper velocity detected by the sensors. This gives rise to the possibility that the damper D cannot exert the target damping force despite an attempt to suppress resonance of the unsprung member W, which lowers the ride quality of the vehicle.

In contrast, the present embodiment determines nothing but the level of the damping force characteristics, that is to say, which damping force characteristics to use in a range from fully soft damping force characteristics to fully hard damping force characteristics, on the basis of the vibration level r. Therefore, the present embodiment does not calculate an electric current instruction using the aforementioned damper velocities with a large difference. As a result, the ride quality of the vehicle is not lowered.

Although the level calculation signals are generated for detection of the vibration level r and the maximum value among the generated level calculation signals is used as the vibration level r in the above-described embodiment, it is sufficient to use the value of the maximum amplitude of information that is arbitrarily selected from among the displacement, velocity, and acceleration of the unsprung member W as the vibration level. Therefore, one of the displacement, velocity, and acceleration may be selected, and the length of a synthetic vector of the selected information and an integrated or differentiated value of the selected information may be obtained as the vibration level.

Furthermore, as stated earlier, the vibration level r of the unsprung member W can be substituted with a vibration level that is obtained by detecting vibration information of the sprung member B. The vibration level r may be obtained by extracting, from the vibration information of the sprung member B, vibration information of the unsprung member W superimposed with the vibration information of the sprung member B using a band-pass filter.

In a case where the vibration level r is obtained by obtaining information of the unsprung member W using a sensor attached to the unsprung member W, the band-pass filter 23 for extracting the vibration of the unsprung member W need not be used. In this case, it is sufficient to separately execute processing for delaying the phase of the vibration level r relative to the phase of the actual vibration level. Instead of delaying the phase of the vibration level r using a filter, processing for creating a temporal delay may be executed. A delay in the phase of the detected vibration level r relative to the phase of the actual vibration level encompasses a temporal delay in the detected vibration level r relative to the actual vibration level.

A rear wheel of a vehicle passes over a protrusion or a recessed section over which a front wheel thereof has passed. Therefore, in a case where the above-described control is performed on the front-wheel side of a vehicle, the following feedforward control may be performed: the time when the rear wheel passes over the same protrusion or recessed section is estimated from a vehicle speed, and an instruction for the front wheel is simply delayed and used when the rear wheel reaches the protrusion or recessed section.

Although the control unit 2 obtains the control instruction by multiplying the vibration level r by a proportional gain in the above-described embodiment, no limitation is intended in this regard. For example, the control instruction may be obtained by performing map computation from the vibration level r using an arbitrary map, and may be obtained in accordance with a mathematical expression that uses the vibration level r as a parameter.

The damper control device E according to the present embodiment controls the damper D using the proportional solenoid valve 18. The damper D provided with the proportional solenoid valve 18 achieves appropriate damping force characteristics on the extension side and the compression side (characteristics defined by an orifice, an extension-to-compression ratio representing a ratio between an extension-side damping force and a compression-side damping force, and the like) for a vehicle, regardless of the amount of electric current supplied to the proportional solenoid valve 18. In this way, resonance of the unsprung member W can be suppressed without impairing the ride quality of the vehicle. That is to say, as resonance is suppressed by applying an electric current corresponding to the vibration level r to the solenoid only when the unsprung member W vibrates, the ride quality of the vehicle is not lowered.

In the above-described embodiment, as the proportional solenoid valve 18 is used as the damping force adjustment unit, the electric current instruction is used as the control instruction in the control unit 2. It is sufficient that the control instruction is an instruction suited for the damping force adjustment unit. Therefore, in a case where the damping force adjustment unit is composed of elements other than the proportional solenoid valve 18, for example, a rotary valve and a stepper motor, it is sufficient that the control instruction is the number of generated pulses. In a case where a working fluid within the damper D is a viscous electrofluid, it is sufficient that the control instruction is a voltage instruction as the damping force adjustment unit generates an electric field.

It is sufficient that the damper control device E is provided with, for example, the following hardware resources (not shown): an A/D converter for loading a signal output from the stroke sensor 21; a storage device, such as a read-only memory (ROM), that stores a program used in processing necessary for detection of a vibration level and computation of an electric current value I; a computation device, such as a central processing unit (CPU), that executes processing based on the program; and a storage device, such as a random-access memory (RAM), that provides a storage area to the CPU. In this way, the operations of the vibration level detection unit 1 and the control unit 2 can be realized by the CPU executing the program.

In the above-described embodiment, the ripple removal filter 26 is provided so as to remove a high-frequency component included in the vibration level r. The cutoff frequency of the ripple removal filter 26 may vary depending on the magnitude of the value of the vibration level r.

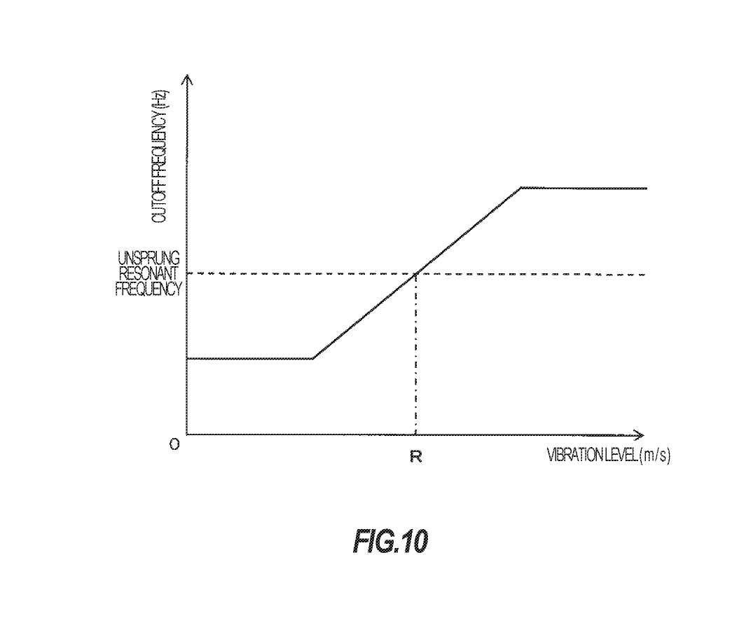

Specifically, as shown in FIG. 10, when the value of the vibration level r is smaller than a predetermined threshold R, the cutoff frequency is set to be equal to or lower than the unsprung resonant

frequency, which is the resonant frequency of the unsprung member W. In a case where the vibration level r is processed using the ripple removal filter 26 with a constant cutoff frequency, if the vibration level r frequently fluctuates when it is low, the influence of sensor noise and other vibration components increases relative to a signal component of vibration information of the unsprung member W in the up-down direction. Therefore, a so-called signal-to-noise ratio worsens, and the accuracy of calculation of the vibration level r lowers. Consequently, in practice, the damping force characteristics corresponding to the condition of the vibration of the unsprung member W cannot be set, and the sprung member B may slightly shake.

In contrast, by setting the cutoff frequency of the ripple removal filter 26 to be lower than the unsprung resonant frequency when the value of the vibration level r is small, even if the vibration level r fluctuates when it is low, the vibration level r processed using the ripple removal filter 26 is smoothed without fluctuating and takes a substantially constant value. In this way, when the vibration level r is low, the damper control device E outputs a substantially constant control instruction, a damping force output from the damper D is stable, and the ride quality of the vehicle is further improved.

Furthermore, in a case where the cutoff frequency is variable, an abrupt change in a control instruction (damping force characteristics) can be suppressed by setting the cutoff frequency to gradually change from a lower limit value to an upper limit value thereof in accordance with the vibration level r, as shown in FIG. 10.

It should be noted that the threshold R can be arbitrarily set to suit an actual vehicle. For example, in a case where the vibration level r of the unsprung member W is measured on the basis of velocity, it is sufficient to set the threshold R to approximately 0.1 m/s. In a case where the vibration level of the sprung member B is used as a substitute, it is sufficient to set the value of the threshold R to suit an actual vehicle.

The foregoing description suggests that, in a case where the vibration level r fluctuates when it is low, the ride quality of the vehicle can be further improved by controlling the damping force characteristics of the damper D without making a control instruction fluctuate, that is to say, with the use of a constant control instruction having a certain arbitrary value, rather than by controlling the damping force characteristics of the damper D with the use of a control instruction obtained from the vibration level r.

Therefore, when the vibration level r is lower than the threshold R, similar advantageous effects can be achieved by setting a control instruction having a certain constant value, instead of making the cutoff frequency of the ripple removal filter 26 variable. Thus, in such a situation, instead of setting a control instruction having a constant value, it is permissible to make resistance to fluctuations by applying moving average processing to the vibration level r, and it is also permissible to remove a fluctuation component from the vibration level r by applying a notch filter only to a unsprung resonant frequency band or to a frequency band of a frequency that is double the unsprung resonant frequency.

Embodiments of the present invention were described above, but the above embodiments are merely examples of applications of the present invention, and the technical scope of the present invention is not limited to the specific constitutions of the above embodiments.

With respect to the above description, the contents of application No. 2013-265226, with a filing date of Dec. 24, 2013 in Japan, are incorporated herein by reference.

1. A damper control device for controlling vibration of an unsprung member of a vehicle by controlling damping force characteristics of a damper relative to an extension/compression velocity of the damper, the damper being interposed between a sprung member and the unsprung member of the vehicle, the damper control device comprising:
a vibration level detection unit configured to detect a vibration level of the unsprung member; and
a control unit configured to control the damping force characteristics of the damper by obtaining a control instruction, the control instruction determining the damping force characteristics on the basis of the vibration level detected by the vibration level detection unit, wherein
the control instruction obtained by the control unit is proportional to the vibration level.

2. The damper control device according to claim 1, wherein
the vibration level detection unit detects the vibration level of the unsprung member on the basis of one of an acceleration of the sprung member in an up-down direction, a velocity of the sprung member in the up-down direction, and a displacement of the sprung member in the up-down direction.

3. The damper control device according to claim 1, wherein
the vibration level detected by the vibration level detection unit is delayed in phase relative to an actual vibration level of the unsprung member.

4. The damper control device according to claim 1, wherein
when the vibration level is lower than a predetermined threshold, the vibration level detection unit detects the vibration level with removal of a frequency component having a frequency equal to or higher than a resonant frequency of the unsprung member.

5. The damper control device according to claim 1, wherein
the damper includes:
a cylinder:
a piston slidably inserted into the cylinder:
an extension-side chamber and a compression-side chamber partitioned by the piston in the cylinder:
a damping force adjustment passage permitting a working fluid to pass therethrough both during extension and compression, the damping force adjustment passage being configured to apply resistance to a flow of the passing working fluid; and
a proportional solenoid valve provided in the damping force adjustment passage, the proportional solenoid valve being configured to change the damping force characteristics of the damper, and
the control unit controls the damping force characteristics by issuing the control instruction to the proportional solenoid valve.

6. (canceled)
